(19) United States
(12) Patent Application Publication
(10) Pub. No.: US 2009/0007442 A1
(43) Pub. Date: Jan. 8, 2009

(54) Razor Implement

(76) Inventor: Noboru Kurihara, Gunma (JP)

Correspondence Address: Patrick G Burns;Greer Burns & Crain, 300 S Wacker Drive, Suite 2500, Chicago, IL, 60606, US

(21) Appl. No.: 11/658,607

(22) PCT Filed: Jul. 27, 2006
(86) PCT No.: PCT/JP2006/314883

§ 371 Date: Jan. 25, 2007

(30) Foreign Application Priority Data
Sep. 16, 2005 (JP) JP2005-270190
Sep. 16, 2005 (JP) JP20050270189

(51) Int. Cl. B26B 21/52; B26B 21/40

(52) U.S. Cl. 30/526; 30/537

(57) ABSTRACT

The present invention provides a razor implement which can be satisfactorily used by those who are accustomed to using razor implements, and exhibits an extremely high safety during shaving. The razor implement of the first present invention is a razor implement in which a safety guard 30 having slits exposing the blade edge of a blade by specified intervals and bridges covering the blade edge at a plurality of positions is mounted on the blade fitted at the tip part of a handle, and the slits of the safety guard 30 are constituted by providing the first slits 33 formed at the central part of the blade edge, the second slits 34 formed with smaller widths than the widths of the first slits on the tip side of the blade edge, and the third slits 35 formed with smaller widths than the widths of the first slits on the proximal end part side of the blade edge. In addition, the razor implement of the second present invention is a razor implement wherein a safety guard having slits exposing the blade edge of a blade by specified intervals and bridges covering the blade edge at a plurality of positions is mounted on the blade fitted on the tip part of a handle, and in the razor implement mounted with the safety guard equipped with the bridges covering the blade edge at a plurality of positions, the slits of the safety guard are constituted by providing a first sub-slit 134 formed by the tip part of the blade edge, a second sub-slit 135 adjoining the first sub-slit and formed with a smaller width than the width of the first sub-slit, a third sub-slit 136 adjoining the second sub-slit and formed with a smaller width than the width of the second sub-slit, and a plurality of main slits 137 formed by adjoining the third sub-slit.

### TECHNICAL FIELD

The present invention relates to a razor implement.

### BACKGROUND ART

FIG. 4 shows a razor implement 1 which has been recently used by mainly female persons when they shave the downy hair on the surfaces of their faces or they adjust lines of their eyebrows.

This type of the razor implement 1 is constituted of a handle 2 which a user grips with a hand and a blade 3 fitted on the tip part of the handle 2.

The razor implement like this is usually formed by mounting a safety guard 4 on the blade edge 3a so that the user does not injure the skin even when the user erroneously operates the razor implement 1 in the direction along the blade edge 3a while the user applies the blade edge 3a on the skin.

This safety guard 4 is ordinarily constituted by punching a plurality of slits 6 along the longitudinal direction on a stainless steel sheet 5 with a length shorter than the dimension of the length of the blade edge 3a and formed into a thin sheet-like shape so as to form a number of long and slender bridges 7 extending in the crosswise width direction as shown in FIG. 5 and FIG. 6.

When this safety guard 4 is mounted on the blade edge 3a, it is constituted in such a way that as shown in FIG. 6, the stainless steel sheet 5 is bent at an intermediate part in the crosswise width direction and the blade edge 3a is covered with the sheet so as to expose the tip 3b of the blade edge 3a, and both end parts in the crosswise width direction of the stainless steel sheet 5 are respectively spot-welded on both side faces of the blade 3.

Here, in the safety guard for the razor implement having been conventionally used, as shown in FIG. 4 to FIG. 6, the slits 6 formed into the safety guard 4 are all circular holes provided with semi-circular arcs on both sides of parallel part, and the widths of the slits 6 parallel to the longitudinal direction of the stainless steel sheet 5 are formed into approximately 1.0 mm, and the widths of the bridges located between adjoining slits 6 and 6 are formed into approximately 0.3 mm. The safety guard 4 thereby prevents the blade edge 3a from skidding by respective bridges 7.

In addition, the tip 3b of the blade edge 3a is exposed without being covered by the safety guard 4, and by using the tip 3b of the blade edge 3a, such a delicate operation as adjusting the lines of the eyebrows one by one can be performed.

Namely, the safety guards in the razor implements which have been conventionally used, are ordinarily constituted so that respective slits have all the same shapes and the same dimensions, and the tip 3b of the blade edge 3a is exposed.

On the other hand, as the other example of the razor implement, as shown in FIG. 7 and FIG. 8, there exist such examples that modify the constitutions (such as the shapes and the dimensions) of the slits of the safety guards, which have been already proposed by an inventor of the present invention (for example, refer to the patent literature 1).

The slits of the safety guard 8 in the razor implement shown in FIG. 7 and FIG. 8 are constituted of a first sub-slit 11 with one hole formed by the side of the tip 3b of the blade edge 3a, a second sub-slit 12 with one hole by the side of the tip 3b of the blade edge 3a and formed so as to adjoin the first sub-slit 11, and furthermore, a plurality of main slits 13 formed to the opposite side (root side of the handle) toward the back in the longitudinal direction of the tip 3b of the blade edge 3a so as to adjoin the second sub-slit 12 on a part except a part by the side of the tip 3b of the blade edge 3a, so that the slits are equipped with a plurality of circular holes forming circular arcs on both sides of parallel lines along the longitudinal direction from the tip 3b of the blade edge 3a.

Here, the width 14 parallel to the longitudinal direction of the stainless steel sheet 9 in the first sub-slit 11 is formed to be at least 0.8 mm and at most 3.0 mm so as to prevent the blade from skidding and to form a safe and relief shaving width without wounding the skin, and the width 15 parallel to the longitudinal direction of the stainless steel sheet 9 in the second sub-slit 12 is formed smaller than the width 14 of the first sub-slit 11 and to be at least 0.3 mm and smaller than 0.8 mm so as to be a double structure for further preventing the blade from skidding, and the width 17 of the bridge 16 formed between the first sub-slit 11 and the second sub-slit 12 is formed to be 0.1 mm to 0.3 mm. In addition, in the figure, 18 shows depths (crosswise width of the slit parts) of the first sub-slit 11 and the second sub-slit 12.

On the other hand, the main slit 13 consists of a first main slit 19, a second main slit 20 and a third main slit 21, and the first main slit 19 is formed at a position which is approximately one third of the longitudinal direction of the blade edge 3a, and at the center, namely, is frequently used in the longitudinal direction of the blade edge 3a. The second main slit 20 is formed at a position which is on the tip 3b side being approximately one third at the front of the blade edge 3a, and the third main slit 21 is formed on the opposite side of the tip 3b being approximately one third at the rear in the longitudinal direction of the blade edge 3a. In addition, the widths 22 parallel to the longitudinal direction of the stainless steel sheet 9 in respective main slits 19, 20 and 21 are formed at least 0.8 mm and smaller than 3.0 mm, and the widths 25 of bridges 10 formed between the first main slit 19, the second main slit 20 and the third main slit 21 are formed within a range of 0.1 mm to 0.3 mm so as to be the same as that of the bridge 16 for the first sub-slit 11 and the second sub-slit 12.

In addition, in the figure, 22 indicates the width of the first main slit, 23 indicates the width of the second main slit, and 24 indicates the width of the third main slit 21, and 26 indicates the depth (crosswise width of the slit part) of the main slit 13.

Thereby, the safety guard 8 is made into a double structure wherein skidding can be prevented from occurring by providing the bridge 16 forming the first sub-slit 11 and the second sub-slit 12, and in the operation for the user to adjust the lines of the eyebrows and undulation parts of the face, even a beginner can use it without anxiety.

However, when like the above described razor implement shown in FIG. 7 and FIG. 8, the first sub-slit 11 and the second sub-slit 12 are formed in the safety guard 8 of the razor implement, and the width of the main slit 13 is made at least 0.8 mm and at most 3.0 mm, female persons and beginners can safely use the razor implement, but on the contrary, there exists a problem firstly that it is impossible to perform shaving obliquely and shaving deeply, and shaving efficiency (the amount of shaving per one time) can not be improved, and those who are accustomed to using the razor can not satisfactorily use the razor on the contrary.

Secondly, there exists another problem that only by simply widening the width of the main slit 13, when shaving obliquely or shaving deeply is performed, there exists a fear of that the blade edge 3a of the main slit 13 on the proximal end side is brought into contact with the skin to slightly cut the skin, and therefore, it can not be used without anxiety.

Thirdly, there exists furthermore another problem described as follows. Even when the first sub-slit 11 and the second sub-slit 12 are formed in the safety guard 8 of the razor implement 1, depending on a method for operating for adjusting the lines of eyebrows and the undulations of the face by the user, there exists a fear of bringing a part of the blade exposed from the main slit 13 into contact with the skin and slightly cutting the skin, and also skidding, so that it has been required to further improve its safety. In particular, apart from an ordinary method for use by which a hair adjusting operation of eyebrows is performed by holding the handle 2 of the razor implement by a way for holding chopsticks, in another way of use wherein the hair adjusting operation for eyebrows or the like is performed by holding the handle 2 of the razor implement by a way for holding a knife or a fork, there exists a fear of bringing a part of the blade exposed from the main slit 13 into contact with the skin and cutting slightly the skin.

Patent literature 1: Japanese Patent Application Kokai Publication No. 2001-129273.

### DISCLOSURE OF INVENTION

Purposes of the present invention are firstly, to provide a razor implement which can be satisfactorily used even by those who are accustomed to using razor implements and can well keep its safety in taking the above described actual circumstances into consideration.

In addition, the purposes of the present invention are secondly, to provide a razor implement which can furthermore improve the safety during shaving in taking the above described actual circumstances into consideration.

The razor implement of the first present invention for achieving the above described purposes is a razor implement in which a safety guard having slits exposing the blade edge of a blade by specified intervals and bridges covering the blade edge at a plurality of positions is mounted on the blade fitted at the tip part of a handle, and the slits of the safety guard are characterized in that the slits are equipped with the first slits formed at the central part of the blade edge, the second slits formed with smaller widths than the widths of the first slits on the distal part side of the blade edge, and the third slits formed with smaller widths than the widths of the first slits on the proximal part side of the blade edge.

In such the razor implement of the first present invention as this, the widths of the first slits are preferably larger than 3.0 mm and at most 6.0 mm.

In addition, it is preferable respectively that the widths of the second slits are at least 0.6 mm and smaller than 3.0 mm, the widths of the third slits are at least 0.6 mm and smaller than 3.0 mm, and the widths of the bridges are at least 0.1 mm and at most 0.5 mm.

In addition, in such the razor implement of the first present invention as this, the existing ratio of the first slits formed at the central part of the blade edge is preferably at least 60% and at most 90% to the sum total of the widths of the whole slits.

The razor implement of the first present invention having the structure described above can perform at least one action among shaving obliquely, shaving deeply and improvement of shaving efficiency by the central part of the blade edge by the first slits while a sufficient feeling of satisfaction, and can improve safety during shaving by the second slits and the third slits.

In addition, as a razor implement for achieving the second purpose described above, the razor implement of the second present invention with the following constitution is provided.

Namely, the razor implement of the second present invention is a razor implement wherein a safety guard having slits exposing the blade edge of a blade by specified intervals and bridges covering the blade edge at a plurality of positions is mounted on the blade fitted on the tip part of a handle, and the razor implement is characterized in that the slits of the safety guard described above are constituted by providing a first sub-slit formed by the tip of the blade edge, a second sub-slit adjoining the first sub-slit and formed with a smaller width than the width of the first sub-slit, a third sub-slit adjoining the second sub-slit and formed with a smaller width than the width of the second sub-slit, and a plurality of main slits formed by adjoining the third sub-slit.

In the razor implement of the second present invention like this, the width of the first sub-slit is preferably at least 0.8 mm and smaller than 3.0 mm.

In addition, at the same time, in the razor implement of the second present invention, it is preferable that the width of the second sub-slit is at least 0.6 mm and smaller than 2.0 mm, the width of the third sub-slit is at least 0.3 mm and at most 0.8 mm, the widths of the main slits are at least 0.6 mm and at most 6.0 mm, and the widths of bridges are at least 0.1 mm and at most 0.5 mm, respectively.

In addition, at the same time, in the razor implement of the second present invention, the main slits are preferably equipped with the first main slits formed at the center of the blade edge frequently used, the second main slits formed on the distal end side of the blade edge by making the widths smaller than the widths of the first main slits, and the third main slits formed on the proximal end side of the blade edge by making the widths smaller than the widths of the first main slits. Namely, it is more preferable that the razor implement of the second present invention is also equipped with the constitution of the razor implement of the first present invention. In addition, in such the constitution as this, it is furthermore preferable that the widths of the second main slits are formed larger than the width of the third sub-slit.

In addition, in this razor implement of the second present invention, it is preferable that the widths of the first main slits among the main slits are larger than 3.0 mm and at most 6.0 mm, the widths of the second main slits are at least 0.6 mm and at most 3.0 mm, and the widths of the third main slits are at least 0.6 mm and at most 3.0 mm.

In addition, in such the razor implement of the second present invention as this, the existing ratio of the first main slits is preferably at least 60% and at most 80% to the sum total of all the widths of the main slits.

The razor implement of the second present invention having the structure described above can perform at least one action among shaving obliquely, shaving deeply and improvement of shaving efficiency by the first main slits while a sufficient feeling of satisfaction is obtained, and can improve safety during shaving by the second sub-slits and the third sub-slits.

By using the razor implement of the first present invention, excellent effects that shaving obliquely and shaving deeply can be sufficiently performed, the efficiency of shaving (the amount of shaving per one time) is improved, and those who are accustomed with the razor can satisfactorily use the razor implement, and simultaneously safety can be kept by the constitution of the first slits, the second slits, and the third slits, are succeeded.

In addition, by using the razor implement of the second present invention described above, excellent effects that the blade edge of the main slits can be prevented from coming into contact with the skin and cutting slightly the skin and can be prevented from skidding sufficiently for various methods for operation and holding, and the safety during shaving can be furthermore improved by the constitution of the first sub-slit, the second sub-slit and the third sub-slit, are succeeded.

### BRIEF DESCRIPTION OF DRAWINGS

FIG. 1 is a plan view illustrating an example of one embodiment of a stainless steel sheet constituting a safety guard used for the razor implement of the first present invention, and shows a condition that the stainless steel sheet is not bent before it is mounted on the razor implement.

FIG. 2 illustrates a part of the blade of the razor implement of the first present invention, and a side view showing a condition that the safety guard shown in FIG. 1 is bent and mounted on the blade edge by covering the blade edge.

FIG. 3 illustrates a part of the razor implement of the first present invention, and a side view showing a condition that the blade mounted with the safety guard shown in FIG. 1 and shown in FIG. 2 is furthermore fitted on the tip part of a handle.

FIG. 4 is a side view illustrating a razor implement which has been conventionally used.

FIG. 5 is a plan view illustrating an example of one embodiment of a safety guard used for the razor implement which has been conventionally used, and shows a condition that the safety guard is not bent before mounting it on the razor implement.

FIG. 6 illustrates a part of the razor implement which has been conventionally used, and a side view showing a condition that the safety guard shown in FIG. 5 is bent and mounted on the blade edge by covering the blade edge.

FIG. 7 is a plan view illustrating an example of one embodiment of a stainless steel sheet constituting a safety guard in another embodiment of a razor implement conventionally known.

FIG. 8 shows a part of the blade in the example of other embodiment of the razor implement which has been known conventionally, and is a side view figure illustrating a condition that the safety guard shown in FIG. 7 is bent, covered on the blade edge and mounted there.

FIG. 9 is a plan view illustrating an example of one embodiment of a stainless steel sheet constituting a safety guard used for the razor implement of the second present invention, and shows a condition that the stainless steel sheet is not bent before being mounted on the razor implement.

FIG. 10 shows a part of the blade of the razor implement of the second present invention, and is a side view figure illustrating a condition that the safety guard shown in FIG. 9 is bent, covered on the blade edge and mounted there.

FIG. 11 shows a part of the razor implement of the second present invention, and is a side view figure illustrating a condition that the blade shown in FIG. 10 mounted with the safety guard shown in FIG. 9 is furthermore fitted on the tip part of a handle.

### EXPLANATIONS OF MARKS

1: Razor implement
2: Handle
3: Blade
3a: Blade edge
3b: Tip of the blade edge
3c: Proximal end part
30: Safety guard
32: Bridge
33: First slit
34: Second slit
35: Third slit
36: Width of the first slit
37: Width of the second slit
38: Width of the third slit
39: Width of the bridge
102: Handle
103: Blade
103a: Blade edge
103b: Tip of the blade edge
103c: Central part
103d: Proximal part
130: Razor implement
131: Safety guard
133: Bridge
134: First sub-slit
135: Second sub-slit
136: Third sub-slit
137: Main slit
138: Width of the first sub-slit
140: Width of the second sub-slit
141: Width of the third sub-slit
142: Width of the bridge
143: First main slit
144: Second main slit
145: Third main slit
L: Length (distance) form the tip of the blade edge to the inside (proximal part side)
W: Distance (width) between the tip part position of the blade face side of the handle and the end part position of a slit on the mounting part of the blade (safety guard part)

### BEST MODE FOR CARRYING OUT THE INVENTION

Hereinafter, the present invention is explained while referring to drawings, but at first, hereinafter, the razor implement of the first present invention is explained.

The razor implement of the first present invention is a razor implement in which the blade fitted on the tip part of a handle is mounted with a safety guard having slits exposing the blade edge of a blade at specified intervals and bridges covering the blade edge at a plurality of positions, and the slits of the safety guard is characterized in that the slits of the safety guard are constituted by providing the first slits formed at the central part of the blade edge, the second slits formed with smaller widths than the widths of the first slits on the tip side of the blade edge, and the third slits formed with smaller widths than the widths of the first slits on the proximal part side of the blade edge.

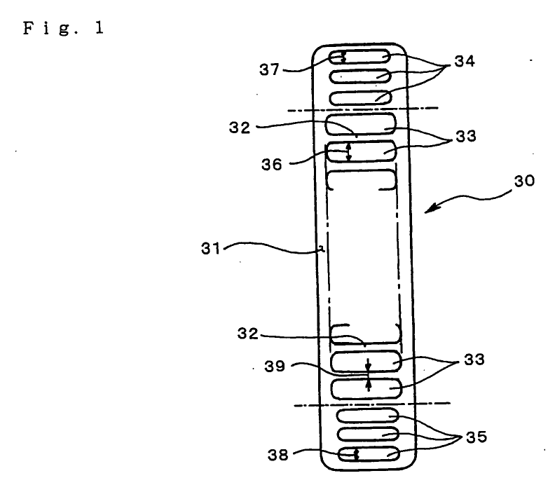

FIG. 1 to FIG. 3 show examples of one practical embodiment of the razor implement of the first present invention like this. FIG. 1 is a plan view illustrating an example of one embodiment of a stainless steel sheet constituting a safety guard used for the first razor implement of the present invention, and shows a condition that it is not bent before being mounted on the razor implement.

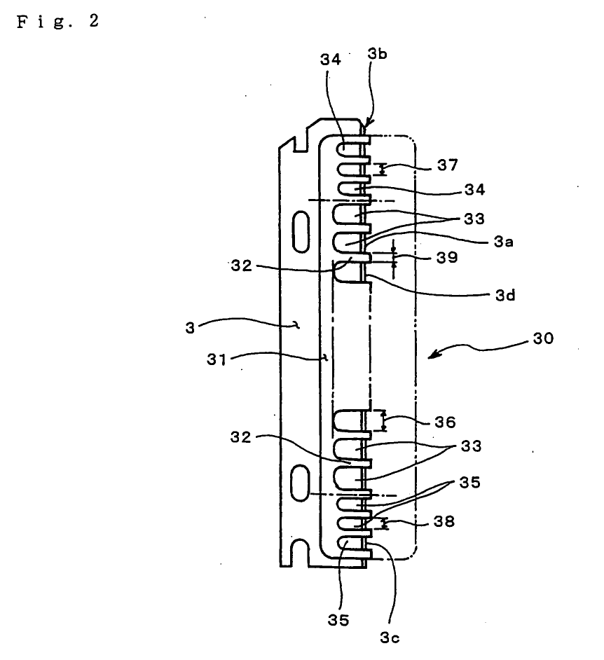

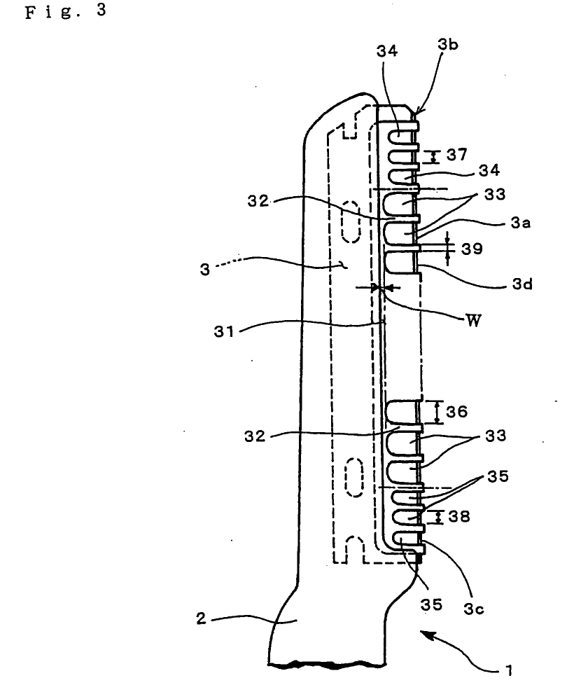

In addition, FIG. 2 shows a part of the blade of the razor implement of the first present invention, and is a side face view illustrating a condition that the safety guard shown in FIG. 1 is bent, covered on the blade edge and mounted there. In addition, FIG. 3 shows a part of the razor implement of the first present invention, and is a side face view illustrating a condition that the blade illustrated in FIG. 2 mounted with the safety guard shown in FIG. 1 is further fitted on the tip part of the handle.

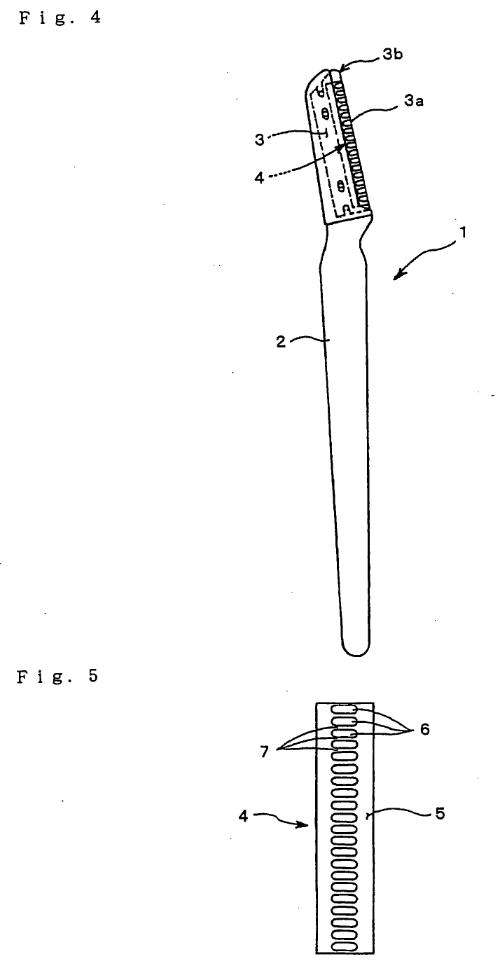

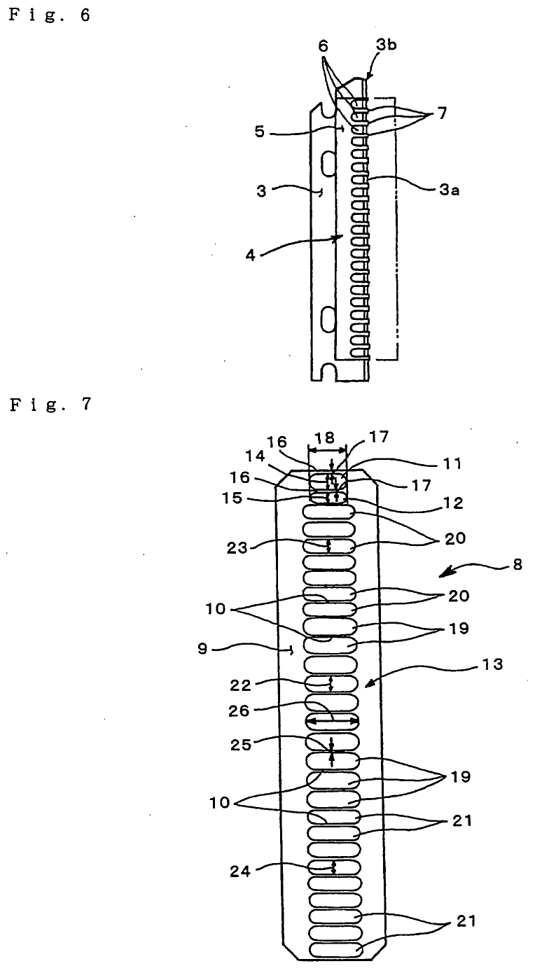

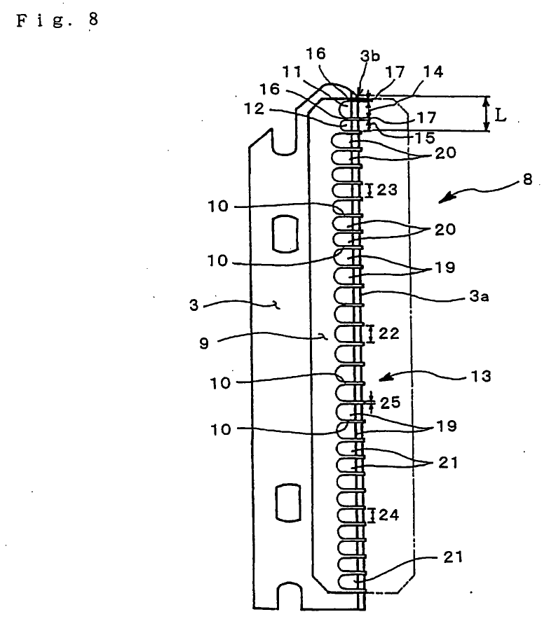

In addition, in these FIGS. 1 to 3, on the same members as those in FIGS. 4 to 8, they are indicated by using the same marks.

In FIG. 1 and FIG. 2, the safety guard 30 is formed by punching-processing a plurality of slits along the longitudinal direction on a stainless steel sheet 31 formed into a thin sheet-like shape so as to form slender and narrow bridges 32 extending in the crosswise width direction, and the whole length of the safety guard 30 is preferably at least 20 mm and at most 50 mm, more preferably at least 33 mm and at most 35 mm so that it becomes approximately the same length as the dimension of the whole length of the blade edge 3a.

The slits of the safety guard 30 is constituted of the first slits 33 formed at the central part 3d of the blade edge 3a, the second slits formed on the tip 3b side of the blade edge 3a, and the third slits 35 formed on the proximal end part 3c side of the blade edge 3a so that a plurality of circular holes forming circular arcs on both sides of parallel lines are equipped from the tip 3b of the blade edge 3a to the proximal end part 3c along the longitudinal direction.

The first slits-33 are formed at the central part 3d in the longitudinal direction of the blade edge 3a, namely, at a position being frequently used, and the existing ratio of the first slits 33 (the ratio of the total sum value of only the widths 36 of the first slits 33 to the total sum value of the widths 36, 37 and 38 of the whole slits) to the total sum value of the widths 36, 37 and 38 of the whole slits (the total sum value of the whole of the widths 36 of the first slits 33, the widths 37 of the second slits 34 and the widths 38 of the third slits 35) is preferably at least 60% and at most 90%, more preferably at least 60% and at most 80%. In addition, the width 36 being parallel to the longitudinal direction of the stainless steel sheet 31 in the first slit 33 is preferably larger than 3.0 mm and at most 6.0 mm, and more preferably at least 3.5 mm and at most 5.0 mm.

The second slits 34 are formed on the tip 3b in the longitudinal direction of the blade edge 3a, and the existing ratio of the second slits 34 (the ratio of the total sum value of only the widths 37 of the second slits 34 to the total sum value of the widths 36, 37 and 38 of the whole slits) to the total sum value of the widths 36, 37 and 38 of the whole slits (the total sum value of the whole of the widths 36 of the first slits 33, the widths 37 of the second slits 34 and the widths 38 of the third slits 35) is preferably at least 5% and at most 20%, more preferably at least 5% and at most 10%.

In addition, furthermore, it is important that the width 37 parallel to the longitudinal direction of the stainless steel sheet 31 in the second slit 34 is smaller than the width 36 of the first slit 33, and furthermore, practically, the width is preferably, at least 0.6 mm and smaller than 3.0 mm, more preferably at least 0.8 mm and at most 2.8 mm.

In addition, here, the existing ratio of the second slits 34 is in a range of not exceeding 100% when it sums up with the existing ratio of the first slits 33 and the existing ratio of the third slits 35.

In addition, the third slits 35 are formed on the proximal end part 3c in the longitudinal direction of the blade edge 3a, and the existing ratio of the third slits (the ratio of the total sum value of only the widths 38 of the third slits 35 to the total sum value of the widths 36, 37 and 38 of the whole slits) to the total sum value of the widths 36, 37 and 38 of the whole slits (the total sum value of the whole of the widths 36 of the first slits 33, the widths 37 of the second slits 34 and the widths 38 of the third slits 35) is preferably at least 5% and at most 25%, and more preferably at least 10% and at most 25%.

In addition, furthermore, it is important that the width 38 parallel to the longitudinal direction of the stainless steel sheet 31 in the third slit 35 is smaller than the width 36 of the first slit 33, and furthermore, practically, the width 38 is preferably at least 0.6 mm and smaller than 3.0 mm, more preferably at least 0.8 mm and at most 2.8 mm.

In addition, here, the existing ratio of the third slits 35 is in a range not exceeding 100% when it sums up with the existing ratio of the first slits 33 and the existing ratio of the second slits 34.

The bridges 32 are formed between the first slits 33, the second slits 34 and the third slits 35, and the width 39 parallel to the longitudinal direction of the stainless steel sheet 31 in the bridge 32 is preferably at least 0.1 mm and at most 0.5 mm, and more preferably at least 0.2 mm and at most 0.5 mm.

A method for mounting the safety guard 30 described above on the blade edge 3a is not specifically limited, but for example, as illustrated in FIG. 2 and FIG. 3, it is preferable that a stainless steel sheet 31 is bent at an intermediate part in the crosswise width direction, and is fitted to the blade edge 3a so as to cover it from the tip 3b to the vicinity of the proximal end part 3c, and both end parts in the crosswise width direction of the stainless steel sheet 31 are respectively fixed by spot-welding them on both side faces.

By the razor implement of the first present invention, by using the razor implement on the blade edge 3a of which the safety guard 30 is mounted, when the mustache, side-whiskers and the like are shaved, as the widths 36 of the first slits 33 are formed with larger widths than the widths of the second slits 34 and the widths of the third slits 35 and are constituted by the existing ratio of at least 60% and at most 90%, the effective range to be shaved by the central part 3d of the blade edge 3a is made favorable and it becomes easily and sufficiently possible for such skilled persons as barbers to perform shaving obliquely in which the blade edge 3a is obliquely brought into contact with the skin and is moved and shaving deeply in which a male person shaves thick mustache or the like.

In addition, at the same time, as the widths 37 of the second slits 34 and the widths 38 of the third slits 35 are formed smaller than the widths 36 of the first slits 33, and they are constituted at the tip 3b of the blade edge 3a and at the proximal end part 3c, it is possible to prevent a possibility of bringing the blade edge 3a of the first slits 33 into contact with the skin and cutting slightly the skin from occurring.

Especially, by the razor implement of the present invention, as the widths 36 of the first slits 33 are formed larger than the widths 37 of the second slits 34 and the widths 38 of the third slits 35, shaving obliquely, shaving deeply and shaving efficiency (amount of the shaving per one time) are improved, and those who are accustomed to using the razor can satisfactorily use the razor implement.

In addition, simultaneously, as the widths 37 of the second slits 34 and the widths 38 of the third slits 35 are made smaller, and they are respectively equipped on the tip 3b and the proximal end part 3c, especially when shaving obliquely is performed, it is prevented to bring the blade edge 3a of the first slits 33 into contact with the skin and to slightly cut the skin from occurring, and safety can be improved thereby. Furthermore, by such constitutions as dimensions and arrangements of the widths 36, 37 and 38 of the first slits 33, the second slits 34 and the third slits 35, skidding can be prevented from occurring, hard shaving can be solved, and shaving efficiency can be improved.

Especially, when the widths 36 of the first slits 33 are made larger than 3.0 mm and at most 6.0 mm, shaving obliquely, shaving deeply and shaving efficiency (amount of shaving per one time) are improved, and those who are accustomed to use the razor can more satisfactorily use the razor implement. In addition, when the widths 36 of the first slits 33 are made at least 3.5 mm and at most 5.0 mm, the above described effects become more remarkable.

When the widths 37 of the second slits 34 are made at least 0.6 mm and smaller than 3.0 mm, and the widths 38 of the third slits 35 are made at least 0.6 mm and smaller than 3.0 mm, and the widths 39 of the bridges 32 are made at least 0.1 mm and at most 0.5 mm, regardless of the existence of the first slits 33, it is prevented from occurring that the blade edge 3a of the first slits 33 come into contact with the skin to slightly cut the skin, and safety can be kept. In addition, when the widths 37 of the second slits 34 are made at least 0.8 mm and at most 2.8 mm, the widths 38 of the third slits 35 are made at least 0.8 mm and at most 2.8 mm, and the widths 39 of the bridges 32 are made at least 0.2 mm and at most 0.5 mm, the above described effects become more excellent.

When the existing ratio of the first slits 33 formed at the central part 3d of the blade edge 3a is made at least 60% and at most 90% to the sum of the widths of the whole slits, shaving deeply and shaving efficiency (amount of shaving per one time) can be improved, and those who are accustomed to using the razor can more satisfactorily use the razor implement. In particular, when the existing ratio of the first slits 33 is made at least 60% and at most 80%, the above described effects become more remarkable, and a more pleasant shaving taste can be achieved.

When the existing ratio of the second slits 34 formed on the tip 3b side of the blade edge 3a is made at least 5% and at most 20% to the sum of the widths of the whole slits, in accordance with the first slits 33, it is possible to prevent that the blade edge 3a of the first slits 33 comes into contact with the skin to slightly cut the skin, and safety can be kept. In addition, when the existing ratio of the second slits 34 is made at least 5% and at most 10%, the above described effects become more remarkable.

When the existing ratio of the third slits 35 formed on the proximal end part 3c side of the blade edge 3a is made at least 5% and at most 25% to the sum of the widths of the whole slits, in accordance with the first slits 33, it is possible to prevent that the blade edge 3a of the first slits 33 comes into contact with the skin to slightly cut the skin, and safety can be kept. In addition, when the existing ratio of the third slits 35 is made at least 10% and at most 25%, the above described effects become more remarkable.

Next, the razor implement of the second present invention will be explained. The razor implement of the second present invention is a razor implement in which the blade fitted on the tip part of a handle is mounted with a safety guard having slits exposing the blade edge of the blade by specified intervals and bridges covering the blade edge at a plurality of positions, and the razor implement is characterized in that the slits of the safety guard are constituted by providing the first sub-slit formed by the side of the tip 3b of the blade edge, the second sub-slit adjoining the first sub-slit and formed with a smaller width than the width of the first sub-slit, the third sub-slit adjoining the second sub-slit and formed with a smaller width than the width of the second sub-slit, and a plurality of main slits adjoining the third sub-slit and formed.

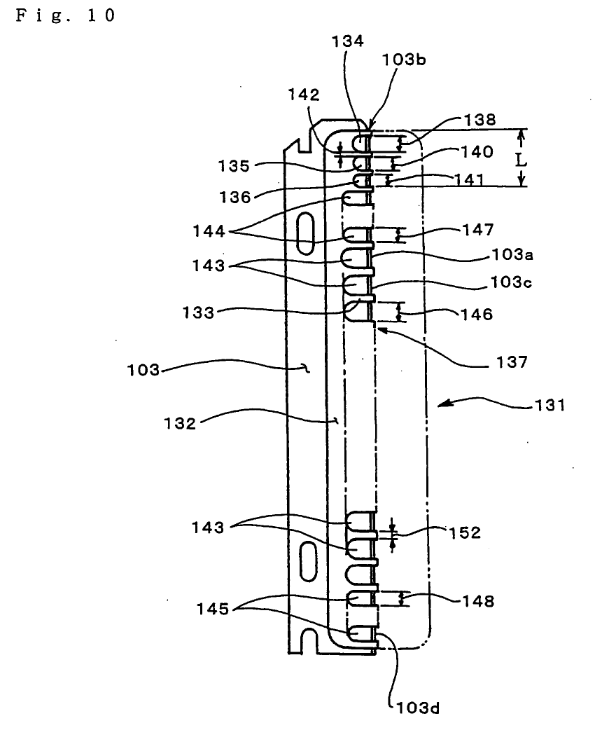

FIG. 9 to FIG. 11 show examples of practical embodiments of the razor implement of the second present invention, and FIG. 9 is a plan view illustrating an example of one embodiment of a stainless steel sheet constituting a safety guard used for the razor implement of the second present invention, which shows a condition that it is not bent before mounting it on the razor implement.

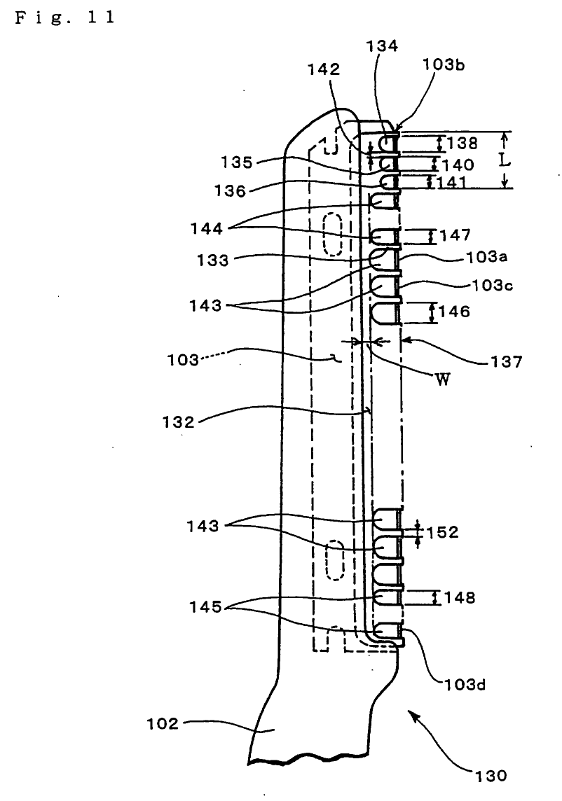

FIG. 10 is a side view illustrating a part of the blade of the razor implement of the second present invention, which shows a condition that the safety guard illustrated in FIG. 9 is bent, covered on the blade edge and mounted thereon.

FIG. 11 is a side view illustrating a part of the razor implement of the second present invention, which shows a condition that the blade shown in FIG. 10 is further fitted to the tip part of the handle.

The razor implement 130 is constituted of the handle 102 for a user to grip it by a hand, and the blade 103 fitted on the tip part of the handle 102 so as to extend along the longitudinal direction of the handle 102.

The safety guard 131 mounted on the blade edge 103a is formed by punching a plurality of slits along the longitudinal direction on a stainless steel sheet 132 so as to form narrow and slender bridges 133 extending in the crosswise width direction, and the total length in the longitudinal direction of the safety guard is preferably at least 20 mm and at most 60 mm, more preferably at least 33 mm and at most 35 mm so as to become approximately the same length as the whole length dimension of the blade edge 103a.

The slits of the safety guard 131 is constituted of the first sub-slit 134 with one hole formed at the tip 103b of the blade edge 103a, the second sub-slit 135 with one hole formed by the side of the tip 103b of the blade edge 103a and adjoining the first sub-slit 134, and the third sub-slit 136 with one hole formed by the side of the tip 103b of the blade edge 103a and adjoining the second sub-slit 135 so as to position on the opposite side of the first sub-slit 134, and furthermore, main slits 137 with a plurality of holes formed from the central part 103c of the blade edge 103a to the proximal end part 103d in the longitudinal direction so as to adjoin the third sub-slit 136 at the opposite side part to the tip 103b of the blade edge 103a. Here, the first sub-slit 134, the second sub-slit 135, the third sub-slit 136 and the main slits 137 are respectively formed with circular holes different in sizes and provided with circular arcs on both sides of parallel part, but as the both sides, except the circular arc-like shape, for example, rectangular-like shapes, polygonal shapes, or other circular holes with patterns with designing effects may be used.

Here, in the first sub-slit 134, the width 138 parallel to the longitudinal direction of the stainless steel sheet 132 is preferably at least 0.8 mm and smaller than 3.0 mm, more preferably at least 1.5 mm and at most 2.9 mm, furthermore preferably at least 1.6 mm and at most 2.8 mm, and the depth 139 approximately vertical to the longitudinal direction of the stainless steel sheet 132 is the same as the depths 149 of the main slits 137 or smaller than them.

Here, in the present invention, “the sub-slit” is defined as those slits that exist within a region of 6 mm or smaller of the blade edge length from the tip (3b and 103b) of the blade edge to the inside (the proximal end part side).

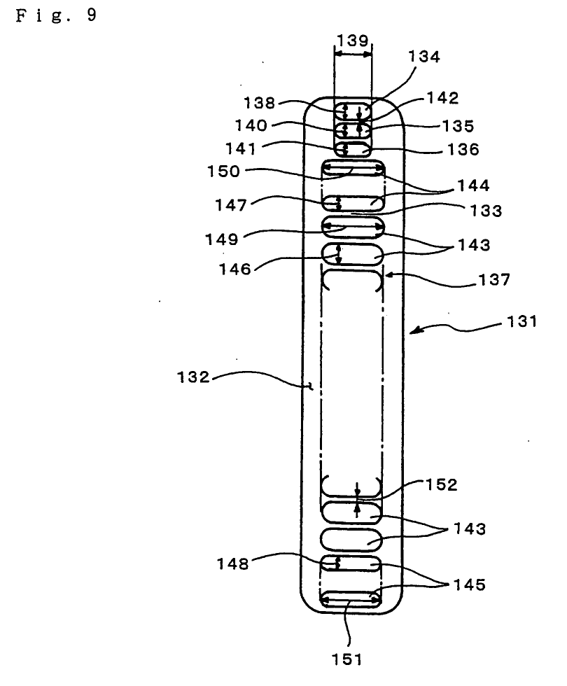

This “sub-slit” is in general, formed with a slit width smaller than the slit width in the longitudinal direction of the blade of the slits (can be called main slit) formed at the central part of the blade edge, but however, the size of the width is not essence so that the sub-slit should not be defined by this (the size of the width), but “a position of formation” that the sub-slit should be formed within 6 mm from the tip of the blade edge is essence and important. Practically, when it is expressed by a figure of an example, those slits that exist in regions where the length (distance) to the inside (proximal end part side) from the tip of the blade edge is within 6 mm are the slits as shown by L in FIG. 8, FIG. 10 and FIG. 11. Therefore, it is not determined only by observing the shape of the slit near the tip formed on the safety guard whether it is the sub-slit or not, and whether the slit corresponds to “the sub-slit” or not can not be determined in accordance with the position of the slit until it is mounted on the blade edge. In addition, those slits which just exist across a point of the distance L=6 mm correspond to the sub-slit as even a part of the blade edge exist with being exposed within the region of 6 mm by the slit.

This sub-slit, when its function is explained, has a different function from the function of the slits (called as main slits) formed at the central part of the blade edge, and has a function which is mainly used as a razor implement for adjusting lines of eyebrows and unevenness of the face by a fine shaving. In addition, it is not specifically restricted but the depth of the sub-slit being the length in the vertical direction to the longitudinal direction of the blade edge, has a depth of 50-100%, namely, about equal to one half in comparison with the depth of the slit (main slit) formed at the central part of the blade edge.

Therefore, those slits which do not exist in a region within 6 mm being the length (distance) from the tip of the blade edge to the inside (proximal end part side), namely, exist furthermore inside (proximal end part side) from a point of 6 mm, are not called “sub-slit” even if the width is smaller or the depth is smaller. In this connection, FIG. 2 shows a razor implement supposing an implement in which a slit 34 at the most apex side is not located within 6 mm from the tip point of the blade, and therefore the slit 34 is not called a sub-slit. However, even for the safety guard shown in FIG. 1, which is the same as shown in FIG. 2, the slit at the tip side corresponds to “the sub-slit” of the present invention depending on a position mounted on the blade edge.

In the examples of practical embodiments of the razor implement of the second present invention as illustrated in FIG. 10 and FIG. 11, for the second sub-slit 135, the width 140 parallel to the longitudinal direction of the stainless steel sheet 132 is formed by a smaller width than the width 138 of the first sub-slit 134, and preferably at least 0.6 mm and smaller than 2.0 mm, more preferably at least 0.8 mm and at most 1.8 mm, and furthermore preferably at least 0.9 mm and at most 1.6 mm, and the depth 139 in the vertical direction to the longitudinal direction of the stainless steel sheet 132 is approximately the same length as that for the first sub-slit 134, and is equal or smaller than the depth 149 of main slits.

In addition, for the third sub-slit 136, the width 141 parallel to the longitudinal direction of the stainless steel sheet 132 is formed by a smaller width than the width 140 of the second sub-slit 135, and is preferably at least 0.3 mm and at most 0.8 mm, especially preferably at least 0.3 mm and at most 0.7 mm, and the depth 139 in approximately vertical direction to the longitudinal direction of the stainless steel sheet 132 is preferably approximately the same length as those of the first sub-slit 134 and the second sub-slit 135, and equal to or smaller than the depths 149 of the main slits 137.

The bridges 133 positioned between the first sub-slit 134, the second sub-slit 135 and the third sub-slit 136 are preferably formed with the same width respectively, and the widths 142 of the bridges 133 parallel to the longitudinal direction of the stainless steel sheet 132 is preferably at least 0.1 mm and at most 0.5 mm, more preferably at least 0.2 mm and at most 0.5 mm.

On the other hand, the main slits 137 are constituted of the first main slits 143 formed approximately at the center of the central part 103c of the blade edge 103a, the second main slits 144 formed on the distal end side of the central part 103c of the blade edge 103a, and the third main slits 145 formed on the proximal end part 103d side of the blade edge 103a.

The first main slits 143 are formed approximately at the center of the central part 103c of the blade edge 103, namely, at a position frequently (with high frequency) used, and the existing ratio (the ratio of the sum value of only the widths 146 of the first main slits 143) to the sum of the widths 146, 147 and 148 of all the main slits 137 (the sum value of all the widths 146 of the first main slits 143, the widths 147 of the second main slits 144, and the widths 148 of the third main slits 145) is preferably at least 60% and at most 80%. In addition, the width 146 parallel to the longitudinal direction of the stainless steel sheet 132 in the first main slit 143 is preferably larger than 3.0 mm and at most 6.0 mm, more preferably at least 3.5 mm and at most 5.0 mm.

The second main slit 144 is formed on the tip side at the central part 103c of the blade edge 103a, and the existing ratio (the ratio of the sum value of only the widths 147 of the second main slits 144) to the sum of the widths 146, 147 and 148 of all the main slits 137 (the sum value of all the widths 146 of the first main slits 143, the widths 147 of the second main slits 144 and the widths 148 of the third main slits 145) is preferably at least 5% and at most 20%, more preferably at least 5% and at most 10%.

In addition, the width 147 parallel to the longitudinal direction of the stainless steel sheet 132 in the second main slit 144 is preferably made smaller than the width 146 of the first main slit 143, and is preferably formed larger than the width of the third sub-slit 136, and therefore, preferably at least 0.6 mm and at most 3.0 mm, and more preferably, at least 0.8 mm and at most 2.8 mm. In addition, here, the existing ratio of the second main slits 144 is in a range not exceeding 100% when it sums up with the existing ratio of the first main slits 143 and the existing ratio of the third main slits 145.

The third main slits 145 are formed on the proximal end part 103d side at the central part 103c of the blade edge 103a, and the existing ratio (the ratio of the sum value of only the widths 148 of the third main slits 145) to the sum of the widths 146, 147 and 148 of all the main slits 137 (the sum value of all the widths 146 of the first main slits 143, the widths 147 of the second main slits 144 and the widths 148 of the third main slits 145) is preferably at least 5% and at most 20%, and more preferably at least 10% and at most 20%.

The widths 148 parallel to the longitudinal direction of the stainless steel sheet 132 in the third main slit 145 are preferably formed smaller than the widths 146 of the first main slits 143 and larger than the width 141 of the third sub-slit 136, and therefore, are preferably at least 0.6 mm and at most 3.0 mm, more preferably at least 0.8 mm and at most 2.8 mm. In addition, the existing ratio of the third main slits 145 is in a range not exceeding 100% when it sums up with the existing ratio of the first main slits 143 and the existing ratio of the second main slits 144.

The bridges 133 positioned between the first main slits 143, the second main slits 144 and the third main slits 145 are preferably formed with the same widths 152 respectively, and the widths 152 parallel to the longitudinal direction of the stainless steel sheet 132 of the bridges 133 are preferably at least 0.1 mm and at most 0.5 mm, more preferably at least 0.2 mm and at most 0.5 mm.

By using the razor implement 130 mounted with the safety guard 131 realizing the above described second present invention on the blade edge 103a, when the face is shaved, by providing not only the first sub-slit 134 and the second sub-slit 135 but also the third sub-slit 136, in a method for operating for a user to adjust the lines of eyebrows and the unevenness of the face, it is prevented that the blade edge 103a of the main slits 137 is brought into contact with the skin and slightly cut the skin, and skidding can be sufficiently prevented from occurring.

In addition, the razor implement 130 is equipped with the third sub-slit 136 to separate the first sub-slit 134 and the second sub-slit 135 from the main slits 137, and thereby, even when an ordinary method for holding chopsticks for holding a handle 102 of the razor implement 130 (a method for holding by which the handle 102 of the razor implement 130 is pinched by using the thumb, the forefinger and the middle finger) and a method for holding a knife and a fork for holding the handle 102 of the razor implement 130 (a method for holding by which the handle 102 of the razor implement 130 is wrapped by using the thumb, the forefinger and the palm) are used in the hair adjusting operation of the eyebrows or the like, it is possible to prevent the blade edge 103a of the main slits 137 from coming into contact with the skin and slightly cut the skin, and to prevent sufficiently skidding from occurring.

On the other hand, when the mustache, side-whiskers and the like are shaved, by forming the widths 146 of the first main slits 143 of the main slits 137 larger than the widths 147 of the second main slits 144 and the widths 148 of the third main slits 145, and by constituting it by an existing ratio of at least 60% and at most 80%, an effective range in which the central part 103c of the blade edge 103a can shave is made favorable, and it becomes easily and sufficiently possible for such skilled persons as barbers to perform shaving obliquely in which the blade edge 103a is obliquely brought into contact with the skin and moved and shaving deeply in which a male person shaves thick mustache or the like. In addition, by making the widths 147 of the second main slits 144 smaller than the widths 146 of the first main slits 143 and providing the second main slits 144 on one side of the first main slits 143, and by making the widths 148 of the third main slits 145 smaller than the widths 146 of the first main slits 143 and providing the third main slits 145 on the other side of the first main slits 143, it is possible to prevent the blade edge 103a of the first main slits 143 from coming into contact with the skin to slightly cut it and to prevent sufficiently skidding from occurring.

By the second present invention, as not only the first sub-slit 134 and the second sub-slit 135 but the third sub-slit 136 are equipped, in a method for operating for the user to adjust the lines of the eyebrows and the uneven parts of the face, the blade edge 103a of the main slits 137 is prevented from coming into contact with the skin and slightly cut the skin, and is sufficiently prevented from skidding to be able to furthermore improve safety during shaving.

When the width 138 of the first sub-slit 134 is made at least 0.8 mm and smaller than 3.0 mm, the width 140 of the second sub-slit 135 is made at least 0.6 mm and smaller than 2.0 mm, the width 141 of the third sub-slit 136 is made at least 0.3 mm and at most 0.8 mm, the widths 146, 147 and 148 of the main slits 137 are made at least 0.6 mm and at most 6.0 mm, and the widths 142 of the bridges 133 are made at least 0.1 mm and at most 0.5 mm, respectively, the first sub-slit 134, the second sub-slit 135, the third sub-slit 136 and the main slits 137 can be arranged at a good balance, and even in various methods for operation and various methods for holding, the blade edge 103a of the main slits 137 are prevented from coming into contact with the skin and slightly cutting the skin, and sufficiently prevented from skidding to be able to further improve the safety during shaving.

When the width 138 of the sub-slit 134 is made at least 1.5 mm and at most 2.9 mm, the width 140 of the second sub-slit 135 is made at least 0.8 mm and at most 1.8 mm, the width 141 of the third sub-slit 136 is made at least 0.3 mm and at most 0.7 mm, the widths 146, 147 and 148 of the main slits 137 are made at least 0.6 mm and at most 6.0 mm, and the widths 142 of the bridges 33 are made at least 0.2 mm and at least 0.5 mm, respectively, they can be favorably arranged at a good balance to still furthermore improve the safety during shaving.

Furthermore, the width 138 of the first sub-slit 134 is made larger than 1.6 mm and at most 2.8 mm, the width 140 of the second sub-slit 135 is made at least 0.9 mm and at most 1.6 mm, the width 141 of the third sub-slit 136 is made at least 0.3 mm and at most 0.7 mm, the widths 146, 147 and 148 of the main slits 137 are made at least 0.6 mm and at most 6.0 mm, and the widths 142 of the bridges 133 are made at least 0.2 mm and at most 0.5 mm, respectively, respective constitutions can be favorably arranged at the best balance, and furthermore, the skidding can be enough prevented from occurring to furthermore improve the safety during shaving.

In addition, when the main slits 137 are equipped with the first main slits 143 formed at the center of the blade edge 103a frequently used, the second main slits 144 formed on the tip side of the blade edge 103a with widths being smaller than the widths 146 of the first main slits 143 and larger than the widths 148 of the third main slits 145, and the third main slits 145 formed on the proximal end part 103d side of the blade edge 103a with widths being smaller than the widths 146 of the first main slits 143, the widths 146 of the first main slits 143 are formed larger than the widths 147 of the second main slits 144 and the widths 148 of the third main slits 145, it is possible to improve shaving obliquely, shaving deeply and shaving efficiency (amount of shaving per one time), and for the persons who are accustomed to use the razor implements to satisfactorily use it.

In addition, simultaneously the widths 147 of the second main slits 144 are made smaller than the widths 146 of the first main slits 143 and are equipped by one side of the first main slits 143, and the widths 148 of the third main slits 145 are made smaller than the widths 146 of the first main slits 143 and are equipped by the other side of the first main slits 143, the blade edge 103a of the first main slits 143 is prevented from coming into contact with the skin and slightly cutting the skin, and is enough prevented from skidding to be able to keep the safety.

In addition, as the third main slits 145 with the widths smaller than the widths 146 of the first main slits 143 are equipped on the proximal end part 103d side of the blade edge 103a, especially when shaving obliquely is performed, the blade edge 103a of the first main slits 143 can be prevented from coming into contact with the skin and cutting slightly the skin, and can be enough prevented from skidding to sufficiently improve the safety.

Furthermore, in addition, depending on such constitutions as sizes of the widths 146, 147 and 148 and arrangements of the first main slits 143, the second main slits 144 and the third main slits 145, it is possible to prevent skidding from occurring, to solve hard shaving and to improve shaving efficiency.

When the widths 146 of the first main slits 143 of the main slits 137 are made larger than 3.0 mm and at most 6.0 mm, the widths 147 of the second main slits 144 are made at least 0.6 mm and at most 3.0 mm, the widths 148 of the third main slits 145 are made at least 0.6 mm and at most 3.0 mm, as the first main slits 143, the second main slits 144 and the third main slits 145 are arranged at a good balance, shaving obliquely, shaving deeply, and shaving efficiency (amount of shaving per one time) are improved, and those who are accustomed to use the razor implements can more satisfactorily use the razor implement 130, and the blade edge 103a of the first main slits 143 is prevented from coming into contact with the skin and slightly cutting the skin, to be able to keep the safety. In addition, when the widths 146 of the first main slits 143 are made at least 3.5 mm and at most 5.0 mm, the widths 147 of the second main slits 144 are made larger than 0.8 mm and at most 2.8 mm, and the widths 148 of the third main slits 145 are made larger than 0.8 mm and at most 2.8 mm, respectively, respective constitutions can be made furthermore good balance, and skidding can be furthermore prevented from occurring, to keep the safety furthermore.

When the existing ratio of the first main slits 143 of the main slits 137 is made at least 60% and at most 80% to the sum of the widths 146, 147 and 148 of all the main slits 137, deep shaving and shaving efficiency (the amount of shaving per one time) are improved, and those who are accustomed to the razor implements can more satisfactorily use the razor implement 130. In addition, skidding can be prevented from occurring and hard shaving can be solved to be able to achieve a pleasant taste of shaving.

When the existing ratio of the second main slits 144 of the main slits 137 is made at least 5% and at most 20% to the sum of the widths 146, 147 and 148 of all the main slits 137, in accordance with respective sub-slits 134, 135 and 136 and the first main slits 143, the blade edge 103a of the first main slits 143 is prevented from coming into contact with the skin and slightly cutting the skin, to be able to keep the safety. Especially, when the existing ratio of the second main slits 144 is made at least 5% and at most 10%, furthermore, skidding is prevented from occurring to be able to furthermore keep the safety.

In addition, when the existing ratio of the third main slits 145 of the main slits 137 to the sum of the widths 146, 147 and 148 of all the main slits 137 is made at least 5% and at most 20%, in accordance with the first main slits 143, the blade edge 3a of the first main slits 143 is prevented from coming into contact with the skin to slightly cut the skin and to be able to keep the safety. Especially, when the existing ratio of the third main slits 145 is made at least 10% and at most 20%, furthermore, skidding is prevented from occurring to be able to furthermore keep the safety.

In addition, when the depths 139 of the first sub-slit 134, the second sub-slit 135, and the third sub-slit 136 are made shorter than the depths 149, 150 and 151 of the main slits, as the position of the tip 103b of the blade edge 103a can be easily judged, the tip 103b of the blade edge 103a can be favorably used.

A method for mounting the safety guard on the blade edge is explained as follows.

In order to mount the safety guard with the above described slit structure on the blade edge, it can be mounted by the same method for both the razor implement of the first present invention and the razor implement of the second present invention.

Namely, for example, as illustrated in FIG. 10 and FIG. 11, the stainless steel sheet 132 is bent at an intermediate part in the crosswise width direction, and is fitted on the blade edge 103a so as to cover it from the tip 103b to the vicinity of the proximal end part 103d, and both end parts in the crosswise width direction of the stainless steel sheet 132 can be fixed and mounted on both side faces of the blade 103 by spot welding.

Hereinafter, the methods for manufacturing the safety guards illustrated in respective figures and the methods for mounting the safety guard on the blade edge are explained, and these explanations are common for the razor implement of the first present invention and the razor implement of the second present invention.

Namely, the safety guards shown in FIG. 1 and FIG. 9 are formed by punching a plurality of the slits along the longitudinal direction on a stainless steel sheet formed into a thin sheet-like shape so as to form narrow and slender bridges extending in the crosswise width direction.

When the safety guard consisting of the stainless steel sheet like this is mounted on the blade edge, it is preferable that the stainless steel sheet is bent at an intermediate part in the crosswise width direction, and is fitted on the blade edge so as to cover the blade edge from its tip to the vicinity of the proximal end part, and both end parts in the crosswise width direction of the stainless steel sheet are respectively spot-welded, fixed and mounted on both side faces of the blade by a spot welding method.

The stainless steel sheet to be processed into the safety guard can be used as a raw sheet of a stainless steel sheet as it is, but particularly, it can be also used by processing it into a stainless steel sheet colored to various colors, and it is preferable.

Namely, the safety guard can be used by constituting it with a colored stainless steel sheet.

The blade edge on which the safety guard is mounted is ordinarily not colored, but especially by mounting the colored safety guard, it becomes possible without difficulty that the safety guard can be visually confirmed, and consequently, the blade edge and the safety guard can be visually confirmed, and it can becomes naturally possible to be aware of the existence of the safety guard and to recognize the position of the blade edge, to be able to make a user feel ease of use.

The method for coloring the stainless steel sheet is not specially restricted, and it can be performed by various methods.

In particular, when the safety guard is manufactured by using the above described punching processing process, it is preferable to use a method using a colored pre-coated stainless steel sheet being coated with a colored layer as the stainless steel sheet.

Practically, the razor implement with a colored safety guard can be manufactured by a method (a) wherein the slits are punched on the colored pre-coated stainless steel sheet, and the stainless steel sheet a part of the colored pre-coating layer of which is release-processed as described below is bent at the intermediate part in the crosswise width direction, and it is fitted on the blade edge so as to cover it from the tip to the vicinity of the proximal end part, and the release-processed parts are fixed by the spot welding method to mount it, or by a method (b) wherein the slits are punched on the colored pre-coated stainless steel sheet, and the one side of the colored pre-coated stainless steel sheet similarly release-processed is firstly bonded by the spot welding to the one side of the blade edge, and then, the stainless steel sheet is bent at the intermediate part in the crosswise width direction, and the other side is fixed and mounted on the blade edge by the spot welding method.

In addition, when the stainless steel sheet coated with the colored coating layer is used as a material for the safety guard, as bending processing is necessary for mounting the stainless steel sheet on the blade edge, it is important that the colored coating material is suitable for bending processing, and adhesiveness to the stainless steel basis is good.

In addition, as the safety guard is also used as a constitutional material of a part of the razor implement, as the material for the safety guard, furthermore, the material for the colored coating layer, those materials that has water resistance and chemical resistance such as detergent resistance are favorably used. Furthermore, as the razor implement is repeatedly used for a relatively long period, and from a necessity of storing, as the materials for the safety guard, and for the colored coating layer, it is preferable to have such characteristics as weathering properties, durability, moisture resistance and heat resistance.

Especially when a colored coating material is used for the purpose of obtaining a colored safety guard, from a view point to satisfy the above described requiring characteristics, as the coating materials, various coating materials such as thermosetting acrylic resins, thermoplastic acrylic resins, polyester resins or polyurethane resins are preferably used.

The “colors” for coloring are not specifically limited, but chromatic colors are preferable from easiness of visual recognition. As achromatic colors such as black and grey are not good in visual recognition, they are not preferable as the colors for coloring, and the chromatic colors are preferable so that they are easily visible even in a little dark washroom.

For the pigments for coloring, there exists no special restriction, and depending on the knowledge of the present inventors, using for example, such materials as red, pink, green, yellow, blue, pale blue and purple is preferable to make visual recognition good.

For example, practically, when a colored pre-coated stainless steel sheet prepared by coating a stainless steel sheet SUS301 with a thickness of 50 μm with an epoxy undercoating (primer) with a thickness of 2 μm, and by coating thereon with a blue top coating layer comprising a polyester resin with a thickness of 13 μm, is used as the safety guard, the safety guard has above described various characteristics, there exists little possibility of generating cracking on the bent part by bending processing, and it is preferable as adhesiveness of the blade edge to the stainless steel basis is also good.

To integrate the bent safety guard and the blade edge, a method by adhesion or a method by welding is preferable, and in particular, a spot-welding method is preferable. As this spot-welding method, for example, the coating such as the primer layer and the colored top coating layer at the positions to be spot-welded is released partially, for example, into a circular shape with a diameter of approximately 3 mm, and then, while electrodes with a tip diameter of approximately 2 to 3 mm are brought into press contact with both sides of the safety guard, an electric current for welding is energized into the electrodes for approximately 0.01-several seconds, to weld metal matrixes of the blade and the safety guard to be able to bond them together.

In addition, when integration is performed by a method for adhesion using an adhesive without depending on welding, various adhesives are applied on the back face of the colored pre-coated stainless steel sheet, and at first, one side is bonded, and thereafter, bending processing and integration processing of the other side by adhesion is performed and then, if necessary, it is cure by heating to perform mounting.

The razor implement using the colored safety guard has various practical features and advantages in comparison with a case of one using a conventional non-colored safety guard, and can be used as the result.

For example, it is possible to provide an accent rich in an aesthetic sense to the razor implement, and when it is used, visual recognition of the position of the blade edge is facilitated, to bring furthermore safety and a feeling of no anxiety to the users, and in addition, according to colors, it can be used as a mark for distinction on the users and distinction on the purposes of use.

Namely, when the razor implement of the present invention is used for the own face or the like, even when it is used by seeing with the naked eye which is close to or is out of focus to an object such as casting an upward glance, casting a downward glance, and casting a lateral glance, or even in a case when the eyes look at a point such as a position for shaving on a mirror face, and no concentrated attention turns on the blade face and the blade edge of the razor implement, especially by using a razor implement with a colored safety guard, it becomes possible for the user to be aware of the existences, positions and directions of the blade face and the blade edge of the razor implement at real time, and to surely perform the required shaving operation with more safe feeling and more freedom from anxiety.

The safety guard 4 is generally formed of a stainless steel sheet as described above, but it may be formed of an aluminum sheet, or of a synthetic resin sheet.

The method for coloring a metal sheet made of a stainless steel or aluminum is not specifically restricted, and it can be performed by various methods, but in particular, a method wherein the colored metal sheet is formed by covering the sheet made of the stainless steel or the aluminum with a chromatically colored synthetic resin layer, is favorable as color classification is freely possible.

For the material for the safety guard like this, besides the above described thin sheets made of stainless steel or aluminum, a thin steel sheet, a stainless steel wire can be used. In addition, besides the metal materials, for example, synthetic resin sheets such as colored plastic films and resin materials such as resin molded materials can be also used.

According to various knowledge of the present inventors, in order to remarkably exhibiting the effects obtained by using the colored safety guard, it is preferable that the colored safety guard is buried in a handle so that the colored safety guard is continuously exposed with at least definite width over the whole its length direction. FIG. 3 and FIG. 11 explain that, and the distance (width) W between the position of the tip part on the blade face side of the handle on the mounting part of the blade (safety guard part) and the position of the end part of the slits shown in these figures is the said width, and the said width is preferably 0.1 mm to 2 mm, more preferably 0.3 mm to 1.5 mm, and it is preferable that these widths continuously exist and the colored safety guard are exposed.

When the safety guard is integrated by an adhesive method using an adhesive without depending on welding, one of various adhesives is applied on the back face of the colored pre-coated stainless steel sheet or the like, and at first, one side is bonded, and then, after bending processing and adhesive integration of the other side are performed, if necessary, curing by heating is performed to mount the safety guard. However, when the third bonding material such as the adhesive, the whole thickness tends to become thicker at the bonding positions, so that it is important to consider that it becomes within such a thickness that does not obstacle for mounting the blade into the handle.

In addition, the handle to which the blade is fitted is not specifically restricted, but a handle made of a synthetic resin is preferably used. As the handle part ordinarily has a part for covering the blade, namely, a part for covering the safety guard, it is preferably composed of a resin molded article using a semi-transparent or transparent synthetic resin so that the color of the part of the safety guard is not hidden. However, to aim a more design effect or an ease of visual recognition, the handle may be formed with a molded article of an opaque synthetic resin.

In addition, the resin molded article constituting the handle can be colored in either case of using a semi-transparent or transparent synthetic resin or an opaque synthetic resin, and it is also preferable that especially, the handle is composed of a resin molded article having a chromatic color, the same color family as the chromatic color of the safety guard, and with a higher color value.

When the whole razor implement is colored with a chromatic color, not only a design effect with a color, but also an ease of visual recognition on the existence of the position when it is used in a washroom or in a bath room where illumination is rather poor or when it is taken out from stored articles in a pouch, and improvement of safety and operability caused by an ease of recognition of the existing place can be furthermore brought about.

For the method for manufacturing the razor implement of the present invention, the razor implement of the present invention can be manufactured by various methods, and is not particularly restricted, but as a representative one, a method for manufacturing the razor implement wherein slits are punched on a colored pre-coated stainless steel sheet piece or a colored pre-coated aluminum sheet piece with a rectangular shape with a width of approximately 4-8 mm, and a length of approximately 20-40 mm cut in coincide with the dimension of the safety guard, and thereafter, (a) the sheet piece is bent at the intermediate part in the crosswise width direction, and it is fitted on the blade edge so as to cover the blade edge from the tip to the vicinity of the proximal end part, and it is fixed by a spot welding method to mount it, or (b) after one side in the crosswise width direction of the sheet piece is bonded on one side of the blade edge by the spot welding, the stainless steel sheet piece or the aluminum sheet piece is bent at the intermediate part in the crosswise width direction of the sheet piece, and the other side is fixed on the blade edge by the spot welding method to mount it, and furthermore, the blade is fitted on the handle, is the one in which the processes, the operability, its controlling and so on are relatively simple, and which is therefore preferable.

### EXAMPLES

Hereinafter, practical constitutions and effects of the razor implement of the present invention will be explained based on examples.

### Examples 1 and 2, and Comparative Examples 1 and 2

Examples 1 and 2, and Comparative Examples 1 and 2 relate to the razor implement of the first present invention, and as the constitutions of them, the widths of the slits and the existing ratios of the slits are described and shown in Table 1.

Namely, the constitution of the razor implement of Example 1 is equipped with the first slits with a width of 5.0 mm, the second slits with a width of 1.0 mm, and the third slits with a width of 1.0 mm, and the existing ratio of the first slits is 70%, the existing ratio of the second slits is 15%, and the existing ratio of the third slits is 15%.

The constitution of the razor implement of Example 2 is equipped with the first slits with a width of 3.5 mm, the second slits with a width of 1.0 mm, and the third slits with a width of 1.0 mm, and the existing ratio of the first slits is 90%, the existing ratio of the second slits is 5%, and the existing ratio of the third slits is 5%.

In addition, the constitution of the razor implement of Comparative Example 1 has neither second slit nor third slit, and is equipped with only the first slits with approximately equal widths of 5.0 mm, and the existing ratio of the first slits is 100%.

In addition, the constitution of the razor implement of Comparative Example 2 has no third slit, and is equipped with the first slits with a width of 2.0 mm and the second slits with a width of 0.8 mm, and the existing ratio of the first slits is 90%, and the existing ratio of the second slits is 10%.

In addition, on respective razor implements, the feeling of use and the safety are evaluated, and the summaries of these results are shown in Table 1.

For the method for evaluating respective razor implements, ten male monitors with various levels of the degrees of skills use the razor implements of Example 1, Example 2, Comparative Example 1 and Comparative Example 2 by the same methods of use, and under the same conditions, compare with them and evaluate them.

In the evaluation items shown in Table 1, shaving taste (deep shaving), shaving efficiency, oblique shaving, shaving feeling and safety are evaluated by the evaluation levels of four steps on respective razor implements.

Practically explaining the evaluation items, the shaving taste (deep shaving) evaluates ordinary deep shaving, sharpness, cutting feeling and coping with thick beard. The shaving efficiency evaluates shaving speed and the number of repeating so as to measure the amount of shaving per one time. The oblique shaving evaluates oblique movement, a specified angle to the skin, various methods for shaving. The shaving feeling evaluates soft touch, sliding resistance and smoothness. The safety evaluates crosswise skidding and feeling to anxiety.

The evaluations are performed on respective items by ten male monitors by the evaluation levels of four steps of “very satisfactory”, “almost satisfactory”, “unsatisfactory, leave some problems to be solved” and “insufficient”. In Table 1, the four steps are indicated by “⊚”, “◯”, “Δ” and “x”.

TABLE 1

| | | | | Evaluation Items | | | | |
|---|---|---|---|---|---|---|---|---|
| | Constitutional conditions | | | Shaving | Shaving taste | Shaving | Oblique | |
| | First slits | Second slits | Third slits | feeling | (Deep shaving) | efficiency | shaving | Safety |
| Comparative | 5.0 mm | — | — | ◯~⊚ | ◯~⊚ | ◯~⊚ | ◯~⊚ | X~Δ |
| Example 1 | (100%) | | | | | | | |
| Comparative | 2.0 mm | 0.8 mm | — | ◯ | X~Δ | X~Δ | X | ⊚ |
| Example 2 | (90%) | (10%) | | | | | | |
| Example 1 | 5.0 mm | 1.0 mm | 1.0 mm | ⊚ | ⊚ | ◯~⊚ | ◯~⊚ | ◯~⊚ |
| | (70%) | (15%) | (15%) | | | | | |
| Example 2 | 3.5 mm | 1.0 mm | 1.0 mm | ◯ | ◯~⊚ | ◯ | ◯~⊚ | ◯~⊚ |
| | (90%) | (5%) | (5%) | | | | | |

As the results, as shown in Table 1, Example 1 and Example 2 obtained the evaluations being at least almost satisfactory on all the evaluations such as shaving feeling, shaving taste (deep shaving), shaving efficiency, oblique shaving and safety, but on the contrary, in Comparative Example 1, such evaluation that feeling to anxiety is insufficient is obtained, and in Comparative Example 2, such evaluation that shaving efficiency, oblique shaving and shaving feeling are insufficient is obtained.

It is clear that Example 1 and Example 2 on the razor implements of the present invention provide good balances in oblique shaving, deep shaving, shaving efficiency and safety, and satisfactory constitutions.

### Examples 3-6 and Comparative Examples 3-6

Hereinafter, results obtained by using Examples and Comparative Examples on the razor implements of the second present invention and evaluating them, are shown.

### Example 3

The width of the first sub-slit is made 2.5 mm, the width of the second sub-slit is 0.9 mm, the width of third sub-slit is 0.5 mm, the widths of the first main slits are 5.1 mm, the widths of the second main slits are 1.1 mm, and the widths of the third main slits are 1.0 mm, respectively.

### Example 4

The width of the first sub-slit is made 2.8 mm, the width of the second sub-slit is 1.6 mm, the width of third sub-slit is 0.3 mm, the widths of the first main slits are 5.1 mm, the widths of the second main slits are 1.1 mm, and the widths of the third main slits are 1.0 mm, respectively.

### Comparative Example 3

There is no third sub-slit, and the width of the first sub-slit is made 2.5 mm, the width of the second sub-slit is 0.9 mm, the widths of the first main slits are 5.1 mm, the widths of the second main slits are 1.1 mm, and the widths of the third main slits are 1.0 mm, respectively.

### Comparative Example 4

There is no third sub-slit, and the width of the first sub-slit is made 2.8 mm, the width of the second sub-slit is 1.6 mm, the widths of the first main slits are 5.1 mm, the widths of the second main slits are 1.1 mm, and the widths of the third main slits are 1.0 mm, respectively.

### Example 5

The width of the first sub-slit is made 1.7 mm, the width of the second sub-slit is 1.0 mm, the width of third sub-slit is 0.6 mm, the widths of the first main slits are 5.1 mm, the widths of the second main slits are 1.1 mm, and the widths of the third main slits are 1.0 mm, respectively.

### Comparative Example 5

There is no third sub-slit, and the width of the first sub-slit is made 1.7 mm, the width of the second sub-slit is 1.0 mm, the widths of the first main slits are 5.1 mm, the widths of the second main slits are 1.1 mm, and the widths of the third main slits are 1.0 mm, respectively.

### Example 6

The width of the first sub-slit is made 2.0 mm, the width of the second sub-slit is 1.5 mm, the width of third sub-slit is 0.4 mm, the widths of the first main slits are 5.1 mm, the widths of the second main slits are 1.1 mm, and the widths of the third main slits are 1.0 mm, respectively.

### Comparative Example 6

There is no third sub-slit, and the width of the first sub-slit is made 2.0 mm, the width of the second sub-slit is 1.5 mm, the widths of the first main slits are 5.1 mm, the widths of the second main slits are 1.1 mm, and the widths of the third main slits are 1.0 mm, respectively.

As the results, the articles of Examples 3-6 of the razor implements of the second present invention are respectively in various works such as the works for adjusting the lines of the eyebrows and uneven parts of the face, especially in the hair adjusting work for the eyebrows by ways of holding a knife and a fork, and is also excellent in oblique shaving, deep shaving and shaving efficiency.

The articles of Comparative Examples 3-6 are all poor in safety and pleasant shaving feeling.

### Example 7

The razor implement of the first invention having a structure whose outlines are shown in FIG. 1-3, is prepared.

For preparation, the dimension of the blade and the shape of the slits of the safety guard and the like are the same, but a colored pre-coated article is used as the stainless steel sheet for the safety guard (Example 7).

Namely, a dark yellow-colored pre-coated stainless steel sheet formed by coating a SUS301 stainless steel sheet with a thickness of 50 μm with an epoxy undercoating agent (primer) with a thickness of 2 μm, and coating one face thereon with a yellow top coat layer comprising a polyester resin to form the total thickness of approximately 65 μm, is used.

After slits are punching-processed with a slit shape whose outline shape is illustrated in FIG. 1, the pre-coated stainless steel sheet is bent at the middle in the crosswise width direction by making the face side with no resin coating inside, and on four positions (two positions on one face of the surface and back surface) to be spot-welded, the coating resin of the respective resin coating layers are released by a diameter of approximately 2.5 mm.

The blade edge is covered with the pre-coated stainless steel sheet, and while spot welding electrodes with a diameter of 2 mm are brought into press contact with both side faces of the stainless steel sheet, electric current is energized for approximately 1 second to perform spot welding of the safety guard on the blade edge and the safety guard is fixed and mounted on the blade edge.

The blade obtained is fitted on a handle molded with a transparent resin and is fixed thereon. The shape of the handle is molded so as to make the width W shown in FIG. 3 to be W=1.1 mm.

A panel composed of five young female persons uses the razor implements of the first present invention thus obtained for adjusting eyebrows and removing downy hair around the eyebrows and eyes in a rather dark washroom being ordinary as an illumination for the washroom.

When the five persons in the panel are asked on their impressions on the feelings of use of the razor of the present invention, such favorable comments that the position and the direction of the blade edge can be continuously confirmed during operation, and in spite of using an unfamiliar blade, it can be used without being anxiety of safety, are obtained.

### Comparative Example 7

In addition, a razor implement is manufactured in a similar way as Example 7 except that it is manufactured by using a non-colored stainless steel sheet as the safety guard (Comparative Example 7). On feelings of use of this razor implement, five persons of the same panel are asked on their impressions.

As the result, such evaluations that when the downy hair is removed, it can be used with a good feeling of use with the equal level as the article of Example 7, but when it is used for adjusting the shape of the eyebrows, even when they want to recognize the position of the blade edge, the position is hardly recognized clearly, and the eyebrows adjusting operation itself using the razor implement tends to become rather coarse, and the razor implement with a colored safety guard is consequently the best one among them, are obtained.

1. A razor implement is characterized in that it is a razor implement in which a safety guard having slits exposing the blade edge of a blade by specified intervals and bridges covering the blade edge at a plurality of positions is mounted on the blade fitted at the tip part of a handle, and the slits of the safety guard are constituted by providing the first slits formed at the central part of the blade edge, the second slits formed with smaller widths than the widths of the first slits on the tip side of the blade edge, and the third slits formed with smaller widths than the widths of the first slits on the proximal end part side of the blade edge.

2. The razor implement described in claim 1 characterized by the widths of the above described first slits being larger than 3.0 mm and at most 6.0 mm.

3. The razor implement described in claim 1 or 2 characterized by the widths of the above described second slits being at least 0.6 mm and smaller than 3.0 mm, the widths of the above described third slits being at least 0.6 mm and smaller than 3.0 mm, and the widths of the above described bridges being at least 0.1 mm and at most 0.5 mm.

4. The razor implement described in either of claims 1 or 2 characterized by the existing ratio of the above described first slits formed at the central part of the blade edge to the total sum of the widths of all the slits being at least 60% and at most 90%.

5. A razor implement is characterized in that it is a razor implement in which a safety guard having slits exposing the blade edge of a blade by specified intervals and bridges covering the blade edge at a plurality of positions is mounted on the blade fitted on the tip part of a handle, and in the razor implement mounted with the safety guard equipped with the bridges covering the blade edge at a plurality of positions, the slits of the above described safety guard are constituted by providing a first sub-slit formed by the tip part of the blade edge, a second sub-slit adjoining the first sub-slit and formed with a smaller width than the width of the first sub-slit, a third sub-slit adjoining the second sub-slit and formed with a smaller width than the width of the second sub-slit, and a plurality of main slits formed by adjoining the third sub-slit.

6. The razor implement described in claim 5 characterized by the width of the above described first sub-slit being at least 0.8 mm and smaller than 3.0 mm, the width of the above described second sub-slit being at least 0.6 mm and smaller than 2.0 mm, the width of the above described third sub-slit being at least 0.3 mm and at most 0.8 mm, the widths of the main slits being at least 0.6 mm and at most 6.0 mm, and the widths of the above described bridges being at least 0.1 mm and at most 0.5 mm.

7. The razor implement described in claim 5 or 6 is characterized in that the above described main slits are constituted by providing the first main slits formed at the center of the blade edge, the second main slits formed by the tip of the blade edge and with the widths smaller than the widths of the first main slits, and the third main slits formed on the proximal end part side of the blade edge and with the widths smaller than the widths of the above described first main slits.

8. The razor implement described in claim 7 characterized by the widths of the second main slits being formed larger than the width of the third sub-slit.

9. The razor implement described in claim 7 characterized by the widths of the above described first main slits being larger than 3.0 mm and at most 6.0 mm, the widths of the above described second main slits being at least 0.6 mm and at most 3.0 mm, the widths of the above described third main slits being at least 0.6 mm and at most 3.0 mm.

10. The razor implement described in claim 7 characterized by the existing ratio of the above described first main slits to the total sum of the widths of all the main slits being at least 60% and at most 80%.

11. The razor implement described in either of claim 1 or 5 characterized in that the above described safety guard is formed of a material colored with a chromatic color.

12. The razor implement described in claim 11 characterized by the above described safety guard being formed of a stainless steel sheet or an aluminum sheet.

13. The razor implement described in claim 11 characterized in that the above described safety guard is formed of a sheet made of a stainless steel or an aluminum coated with a resin layer colored with a chromatic color.

14. The razor implement described in claim 11 characterized by the distance (width) W between the position of the tip part on the blade face side of the handle at the mounting part of the blade and the position of the end parts of the slits is in a range of 0.1 mm to 2 mm.

15. The razor implement described in claim 11 characterized in that the above described handle comprises a molded article of a transparent or translucent resin.

16. The razor implement described in claim 11 characterized in that the above described handle comprises a molded article of an opaque resin.
